(19) United States
(12) Patent Application Publication
(10) Pub. No.: US 2021/0319456 A1
(43) Pub. Date: Oct. 14, 2021

(54) METHODS, APPARATUSES, DEVICES, AND SYSTEMS FOR GENERATING CUSTOMS CLEARANCE CONFIRMATION INFORMATION

(71) Applicant: ALIPAY (HANGZHOU) INFORMATION TECHNOLOGY CO., LTD., Hangzhou (CN)

(72) Inventor: Lei Huang, Hangzhou (CN)

(73) Assignee: ALIPAY (HANGZHOU) INFORMATION TECHNOLOGY CO., LTD., Hangzhou (CN)

(21) Appl. No.: 17/357,923

(22) Filed: Jun. 24, 2021

(30) Foreign Application Priority Data
Aug. 13, 2020 (CN) 202010810312.4

(51) Int. Cl. G06Q 30/00; G06Q 20/38; G06Q 10/08; G06Q 40/02; G06Q 20/40; H04L 9/32

(52) U.S. Cl. CPC G06Q 30/018; G06Q 20/389; G06Q 10/0831; H04L 9/3247; G06Q 40/02; G06Q 20/4016; G06Q 20/3825; G06Q 10/0838

(57) ABSTRACT

A customs clearance confirmation information generation computer-implemented method, medium, and system are disclosed. In one computer-implemented method, transaction order information, payment order information, and logistics order information for a first transaction are received from a blockchain network. The blockchain network includes a merchant, a payment institution, a logistics enterprise, and a supervision institution. A determination is made as to whether the transaction order information, the payment order information, and the logistics order information are consistent. Customs clearance confirmation information is generated in response to determining that the transaction order information, the payment order information, and the logistics order information are consistent. The customs clearance confirmation information includes an indication that the supervision institution permits passage of a product corresponding to the first transaction.

### CROSS-REFERENCE TO RELATED APPLICATION

This application claims priority to Chinese Patent Application No. 202010810312.4, filed on Aug. 13, 2020, which is hereby incorporated by reference in its entirety.

### TECHNICAL FIELD

The present application relates to the blockchain and compliance technical field, and in particular, to methods, apparatuses, devices, and systems for generating customs clearance confirmation information.

### BACKGROUND

During the customs clearance process of a product in a cross-border transaction, the customs office needs to check a transaction order, a payment order, and a logistics order. The three orders need to be checked for consistency before customs clearance. The current practice is as follows: A merchant submits the transaction order and the logistics order to the customs office, then a payment institution submits the payment order to the customs office, and after the customs office collects all data, customs clearance is performed. The operation process is too complex, and there is no method to ensure data security.

### SUMMARY

According to a first aspect, some embodiments of the present specification provide a method for generating customs clearance confirmation information. The method includes the following:

Transaction order information, payment order information, and logistics order information for a first transaction are obtained from a blockchain network, where a merchant, a payment institution, a logistics enterprise, and a supervision institution participate in the blockchain network; whether the transaction order information, the payment order information, and the logistics order information are consistent is determined, to obtain a first determining result; and when the first determining result is yes, customs clearance confirmation information used to indicate that the supervision institution permits passage of a product corresponding to the first transaction is generated.

According to a second aspect, some embodiments of the present specification provide a method for generating customs clearance confirmation information. The method includes the following:

A merchant stores transaction order information for a first transaction in a blockchain network; a payment institution stores payment order information for the first transaction in the blockchain network; the merchant or a logistics enterprise stores logistics order information for the first transaction in the blockchain network; a supervision institution obtains the transaction order information, the payment order information, and the logistics order information from the blockchain network; the supervision institution determines whether the transaction order information, the payment order information, and the logistics order information are consistent, to obtain a first determining result; and when the first determining result is yes, the supervision institution generates customs clearance confirmation information used to indicate that the supervision institution permits passage of a product corresponding to the first transaction.

According to a third aspect, some embodiments of the present specification provide an apparatus for generating customs clearance confirmation information. The apparatus includes: a first obtaining module, configured to obtain transaction order information, payment order information, and logistics order information for a first transaction from a blockchain network, where a merchant, a payment institution, a logistics enterprise, and a supervision institution participate in the blockchain network; a first determining module, configured to determine whether the transaction order information, the payment order information, and the logistics order information are consistent, to obtain a first determining result; and a customs clearance confirmation information generation module, configured to generate customs clearance confirmation information when the first determining result is yes, where the customs clearance confirmation information is used to indicate that the supervision institution permits passage of a product corresponding to the first transaction.

According to a fourth aspect, some embodiments of the present specification provide a device for generating customs clearance confirmation information. The device includes: at least one processor; and a memory communicatively connected to the at least one processor, where the memory stores instructions that can be executed by the at least one processor, and the instructions are executed by the at least one processor, so that the at least one processor can:

obtain transaction order information, payment order information, and logistics order information for a first transaction from a blockchain network, where a merchant, a payment institution, a logistics enterprise, and a supervision institution participate in the blockchain network; determine whether the transaction order information, the payment order information, and the logistics order information are consistent, to obtain a first determining result; and when the first determining result is yes, generate customs clearance confirmation information used to indicate that the supervision institution permits passage of a product corresponding to the first transaction.

According to a fifth aspect, some embodiments of the present specification provide a computer-readable medium, where the computer-readable medium stores computer-readable instructions, and the computer-readable instructions can be executed by a processor to implement a method for generating customs clearance confirmation information.

According to a sixth aspect, some embodiments of the present specification provide a system for generating customs clearance confirmation information. The system includes: a merchant, configured to store transaction order information or logistics order information for a first transaction in a blockchain network; a payment institution, configured to store payment order information for the first transaction in the blockchain network; a logistics enterprise, configured to store the logistics order information for the first transaction in the blockchain network; and a supervision institution, configured to obtain the transaction order information, the payment order information, and the logistics order information from the blockchain network, determine whether the transaction order information, the payment order information, and the logistics order information are consistent, to obtain a first determining result, and when the first determining result is yes, generate customs clearance confirmation information used to indicate that the supervision institution permits passage of a product corresponding to the first transaction.

Embodiments of the present specification can achieve the following beneficial effects: A blockchain technology is introduced, so that a merchant, a payment institution, a logistics enterprise, and a supervision institution all participate in the same blockchain. After the merchant creates a transaction order, the merchant stores transaction order information in the blockchain network. After a user makes payment, the payment institution stores payment order information in the blockchain network. After the logistics company generates a logistics order, the logistics company stores logistics order information in the blockchain network. In addition, the supervision institution, as a node in the chain, can obtain information of the three orders for verification, and after the verification succeeds, the supervision institution generates customs clearance confirmation information. The solution not only improves customs clearance efficiency, but also provides data security.

### BRIEF DESCRIPTION OF DRAWINGS

To describe the technical solutions in the embodiments of the present specification or in the existing technology more clearly, the following briefly describes the accompanying drawings needed for describing the embodiments or the existing technology. Clearly, the accompanying drawings in the following description merely show some embodiments of the present application, and a person of ordinary skill in the art can still derive other drawings from these accompanying drawings without creative efforts.

FIG. 1 is a schematic diagram illustrating a scenario of a method for generating customs clearance confirmation information, according to some embodiments of the present specification;

FIG. 2 is a schematic flowchart illustrating a method for generating customs clearance confirmation information, according to some embodiments of the present specification;

FIG. 3 is a schematic flowchart illustrating a method for generating customs clearance confirmation information with a supervision institution as an execution body;

FIG. 4 is a schematic structural diagram illustrating an apparatus corresponding to FIG. 3 and used for generating customs clearance confirmation information, according to some embodiments of the present specification; and

FIG. 5 is a schematic structural diagram illustrating a device corresponding to FIG. 3 and used for generating customs clearance confirmation information, according to some embodiments of the present specification.

### DESCRIPTION OF EMBODIMENTS

To make the objectives, technical solutions, and advantages of one or more embodiments of the present specification clearer, the following clearly and completely describes the technical solutions in the one or more embodiments of the present specification with reference to specific embodiments of the present specification and corresponding accompanying drawings. Clearly, the described embodiments are merely some rather than all of the embodiments of the present specification. All other embodiments obtained by a person of ordinary skill in the art based on the embodiments of the present specification without creative efforts shall fall within the protection scope of the one or more embodiments of the present specification.

The technical solutions provided in the embodiments of the present specification are described in detail below with reference to the accompanying drawings.

Customs clearance (Customs Clearance) refers to formalities that should be performed in accordance with various laws and regulations when an imported, exported, or transshipped cargo enters and exits a country's customs territory. The solutions in the present specification mainly relate to import customs clearance operations on a product that enters the country in a cross-border transaction.

During the customs clearance process of the product in the cross-border transaction, the customs office needs to check a transaction order, a payment order, and a logistics order. The three orders need to be checked for consistency before customs clearance. The current practice is as follows: A merchant submits the transaction order and the logistics order to the customs office, then a payment institution submits the payment order to the customs office, where all data is sent to the customs office by using an API, and after the customs office collects all the data, customs clearance is performed. Data communication can be performed between a plurality of institutions by using a “cross-border e-commerce customs clearance service platform.” The “cross-border e-commerce customs clearance service platform” is a platform built by electronic ports to implement data exchange and information sharing between enterprises, the customs office, and related administrative authorities.

Using the “cross-border e-commerce customs clearance service platform” for data interaction, the customs office can perform the customs clearance operations only after all the data is submitted. If submission of a certain type of data is delayed, the customs clearance operations cannot be performed in time, resulting in low customs clearance efficiency, which obviously cannot meet a growing trend of cross-border transactions. Moreover, the data submitted by the enterprise and related institutions is all submitted by using the API, and there is no method to ensure authenticity of the submitted data.

A blockchain network (Block Chain Network) is a new distributed infrastructure and calculation method that uses a blockchain data structure to verify and store data, uses a distributed node consensus algorithm to generate and update data, uses cryptography to ensure security of data transmission and access, and uses a smart contract formed by automated script code to program and operate data. The blockchain network includes a plurality of nodes. When each node broadcasts information or a block to the blockchain network, all the nodes can receive the information and block and verify the received block. When a ratio of a quantity of nodes that successfully verify the block to a total quantity of nodes in the entire blockchain network is greater than a predetermined threshold, it is determined that the block is successfully verified in the blockchain network, and each node receives the block and stores the block in local node space. The nodes can be understood as electronic devices with storage functions, such as servers and terminals. The chain types of the blockchain network mainly include a public chain, a consortium chain, and a private chain.

A blockchain (Block chain) can be understood as a data chain formed by sequential storage of a plurality of blocks. A block header of each block contains a timestamp of the block, a hash value of previous block information, and a hash value of current block information. As such, mutual verification between blocks is achieved, and a non-tamperable blockchain is formed. Each block can be understood as a data block (unit for storing data). As a decentralized database, the blockchain is a series of data blocks that are correlated and generated by using a cryptographic method. Each data block contains information about a network transaction, where the information is used to verify validity of information of the data block (anti-counterfeiting) and generate a next block. The blocks are connected end to end to form a chain, which is referred to as the blockchain. If data in a block needs to be modified, content of all blocks after this block needs to be modified, and data backed up by all nodes in the blockchain network needs to be modified. Therefore, the blockchain has characteristics of being difficult to tamper with and delete. After data is stored on the blockchain, the blockchain serves as a reliable method to maintain content integrity.

The blockchain technology mainly has the following four characteristics:

(1) Decentralization: It can implement a peer-to-peer transaction, coordination, and collaboration without intervention of a third party. In the blockchain network, no institution or individual can control all the data, and when any node stops working, there is no impact on the overall operation of the system. This decentralized network greatly improves data security.

(2) Non-tamperability: The blockchain uses an encryption technology to verify and store data, and uses a distributed consensus algorithm to add and update data. The blockchain requires all nodes to participate in verifying transactions and generating blocks. When any data is modified, all subsequent records need to be changed. Therefore, it is very difficult to modify data of a single node.

(3) Openness, transparency, and traceability: Written block content is replicated to each node, each node has the latest complete database copy, and all record information is public. Any person can query block data through a public interface. Each transaction on the blockchain is persistently stored in block data through chain storage. In addition, concatenated hash (HASH) digest processing is performed on all transaction records of all blocks by using a cryptographic algorithm, so that any historical transaction data can be traced.

(4) Collective maintainability: The decentralization characteristic of the blockchain network determines collective maintainability of the blockchain network. A traditional centralized institution usually needs to play three roles: a data store, a data manager, and a data analyst. The blockchain network is jointly maintained by all participants equally. All parties have clear rights and responsibilities, and there is no need to transfer rights to a third-party institution to achieve joint collaboration.

Based on the characteristics of decentralization, non-tamperability, openness, transparency, and traceability of the blockchain, this solution proposes a technical solution that not only improves customs clearance efficiency, but also ensures data security. The blockchain technology is introduced, so that a merchant, a payment institution, a logistics enterprise, and a supervision institution all participate in the same blockchain. After the merchant creates an order, the merchant stores order information in the blockchain network. After a user makes payment, the payment institution stores a payment order in the blockchain network. After the logistics company generates a logistics order, the logistics company stores the logistics order in the blockchain network. In addition, the customs office, as a node in the chain, can obtain information of the three orders for verification, and after the verification succeeds, the customs completes customs clearance.

This solution can be applied to cross-border e-commerce. The cross-border e-commerce is an international business activity in which transaction entities belonging to different customs territories conclude a transaction through an e-commerce platform, conduct electronic payment settlement, and deliver a product through cross-border e-commerce logistics and off-site warehousing to complete the transaction. The cross-border e-commerce is divided into export cross-border e-commerce and import cross-border e-commerce. The transactions in this solution are mainly import cross-border transactions.

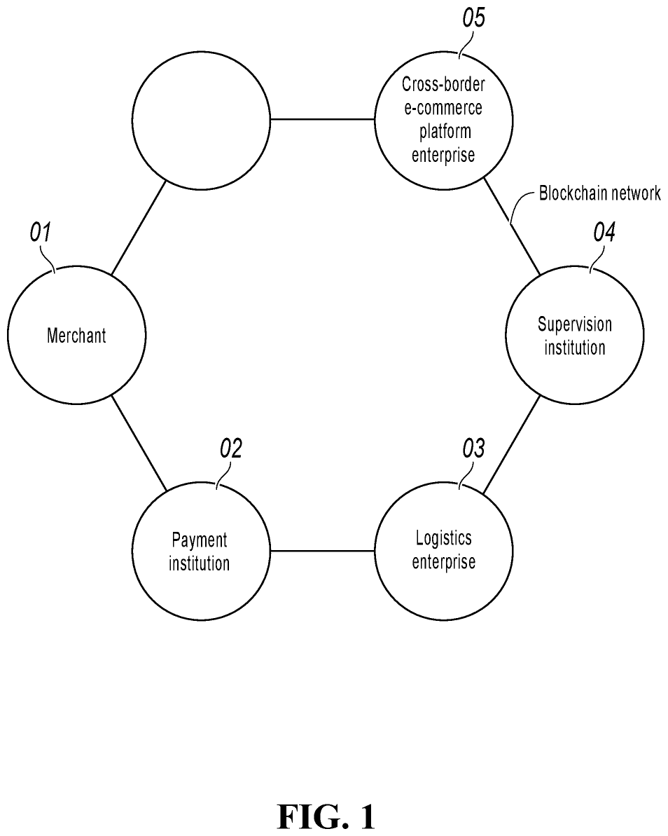

As shown in FIG. 1, users participating in a blockchain network include a merchant 01, a payment institution 02, a logistics enterprise 03, and a supervision institution 04.

The merchant 01 can be a “cross-border e-commerce enterprise” or a “domestic agent of a cross-border e-commerce enterprise.” The “cross-border e-commerce enterprise” is an enterprise registered abroad that sells a retail imported product based on cross-border e-commerce from abroad to a domestic consumer, and is an owner of the product. The “cross-border e-commerce enterprise” can participate in a “cross-border e-commerce platform” (hereinafter referred to as the “platform”) to carry out specific transactions. An enterprise that runs and maintains the “cross-border e-commerce platform” is a “cross-border e-commerce platform enterprise” (hereinafter referred to as the “platform enterprise”). The platform enterprise is an operator that has completed domestic business registration, provides services such as web space, virtual business premises, transaction rules, and information release for both trading parties (the consumer and the cross-border e-commerce enterprise), and establish an information network system for both trading parties to independently carry out transaction activities.

The “domestic agent of the cross-border e-commerce enterprise” is a domestic agent enterprise entrusted by the enterprise registered abroad to carry out cross-border e-commerce retail import business. The domestic agent enterprise shall be registered with the customs office, bear the responsibility of truthful declaration, accept supervision of relevant authorities in accordance with the laws, and bear civil liability. Because the “cross-border e-commerce enterprise” is an enterprise registered abroad, the “cross-border e-commerce enterprise” can entrust the domestic agent enterprise to declare business as an agent.

The payment institution 02 can be a bank, a non-bank payment institution, UnionPay, or the like that has completed domestic business registration and is entrusted by the cross-border e-commerce platform enterprise or the domestic agent of the cross-border e-commerce enterprise to provide cross-border e-commerce retail import payment services. The payment institution 02 can include a bank institution or a non-bank institution. When the payment institution 02 is a bank institution, it shall have a financial license issued by the China Banking and Insurance Regulatory Commission or the original China Banking Regulatory Commission. When the payment institution 02 is a non-bank payment institution, it shall have a payment business license issued by the People's Bank of China, where the scope of payment business should include “Internet payment.”

The logistics enterprise 03 is an enterprise that has completed domestic business registration and is entrusted by the cross-border e-commerce platform enterprise, the cross-border e-commerce enterprise, or the agent of the cross-border e-commerce enterprise to provide cross-border e-commerce retail import and export logistics services. The logistics enterprise shall obtain an express business license issued by the State Postal Administration. In a direct-purchase import model, the logistics enterprise should be a postal enterprise or an inbound and outbound express mail operator who has gone through the agent customs declaration registration formalities with the customs office. In the direct-purchase import model, the postal enterprise or the inbound and outbound express mail operator can be entrusted by the cross-border e-commerce platform enterprise, or the domestic agent of the cross-border e-commerce enterprise, or a payment enterprise to transmit electronic information such as a transaction and payment to the customs office while being committed to bearing corresponding legal responsibilities.

The merchant 01 stores transaction order information in the blockchain network, the payment institution 02 stores payment order information in the blockchain network, and the logistics enterprise 03 stores logistics order information in the blockchain network. For submission efficiency, the transaction order information is stored in the blockchain network immediately after being generated, the payment order information is stored in the blockchain network immediately after being generated, and the logistics order information is stored in the blockchain network immediately after being generated. In addition, the information stored in the blockchain network cannot be tampered with.

Based on an entrusting relationship between the payment institution 02, the logistics enterprise 03, and the merchant 01 or the platform, payment transaction information and logistics order information can also be stored by the merchant 01 in the blockchain network.

In some special cases (for example, in a direct mail mode), the transaction order information, the payment order information, and the logistics order information can also be stored by the logistics enterprise in the blockchain network.

In addition, if the platform enterprise 05 also participates in the chain, the platform enterprise 05 can also store the transaction order information in the chain.

To ensure data reliability, an electronic signature should be added to the data stored in the blockchain network.

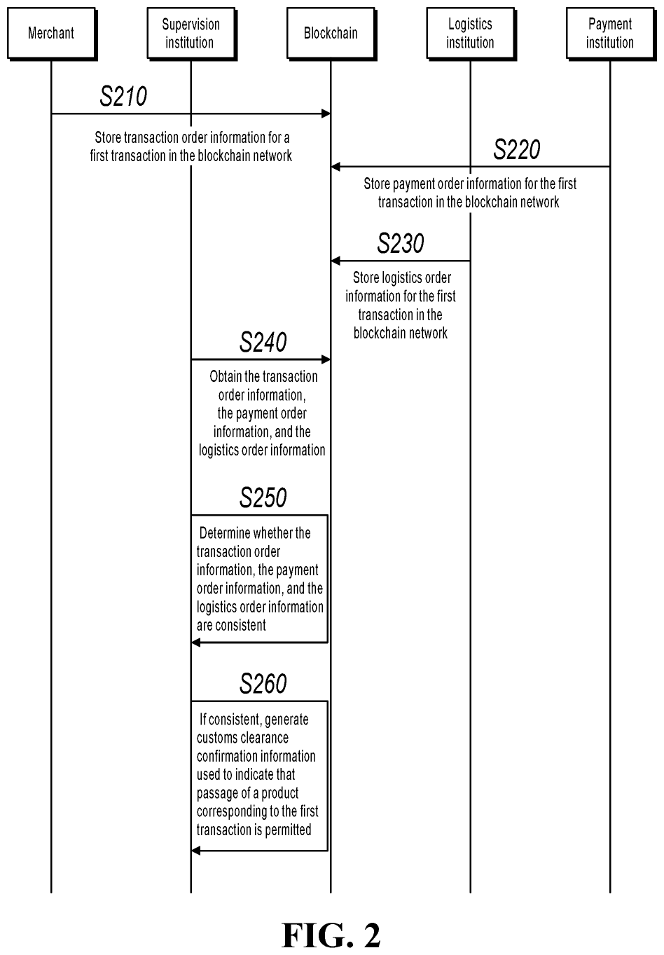

Based on the principle in FIG. 1, some embodiments of the present specification provide a method for generating customs clearance confirmation information. FIG. 2 is a schematic flowchart illustrating a method for generating customs clearance confirmation information according to some embodiments of the present specification. As shown in FIG. 2, the procedure can include the following steps.

Step 210: A merchant stores transaction order information for a first transaction in a blockchain network.

Referring to the explanation about FIG. 1, the merchant can be an enterprise abroad, a domestic agent enterprise of an enterprise abroad, or a platform enterprise. If the merchant is an enterprise abroad, the blockchain network can be a cross-border blockchain. The merchant can interconnect the platform and the blockchain based on settings, obtain transaction order data from the platform by using a specified path, and submit the transaction order data to the blockchain network. Specifically, an API can be used for implementation.

The transaction order information can include buyer information, seller information, a transaction amount, an order generation time, an order number, etc. The seller is the merchant. The buyer is a consumer, and the buyer is also a consignee in logistics information.

The first transaction can be a cross-border transaction.

Step 220: A payment institution stores payment order information for the first transaction in the blockchain network.

The payment institution can be a bank institution, or can be a non-bank institution, for example, a financial institution. After the consumer completes payment, the payment order information is generated. The payment order information can include a payment amount and payer information (the buyer or the consumer). After the payment order information is generated, the payment order information can be stored in the blockchain network.

Step 230: The merchant or a logistics enterprise stores logistics order information for the first transaction in the blockchain network.

The logistics order information can be stored by the merchant or the logistics enterprise in the blockchain network.

If the logistics enterprise is entrusted by the merchant or the platform, the transaction order information and the payment order information can also be stored by the logistics enterprise in the blockchain network.

Step 240: A supervision institution obtains the transaction order information, the payment order information, and the logistics order information from the blockchain network.

The supervision institution here can be the customs office. The supervision institution is also a node in the blockchain network, and can obtain any data from the blockchain network. The supervision institution can obtain data in batches from the blockchain, and then select desired data.

Step 250: The supervision institution determines whether the transaction order information, the payment order information, and the logistics order information are consistent, to obtain a first determining result.

Step 250 can be performed on an independent server of the supervision institution, or can be performed in the blockchain network. If step 250 is performed in the blockchain network, it can be performed by using a smart contract.

Starting from Ethereum, a blockchain technology supports users in creating and invoking some complex logic in the blockchain network. This is one of the greatest advancements of Ethereum relative to a Bitcoin technology. Ethereum is a programmable blockchain, and the core of Ethereum is an Ethereum virtual machine (EVM). Each Ethereum node can run the EVM. The EVM is a Turing-complete virtual machine, which means that the EVM can implement various kinds of complex logic. A user can deploy and invoke the smart contract in Ethereum by using the EVM. In a deployment phase, the user can send a transaction including creation of the smart contract to the Ethereum network, where a data field of the transaction can include code of the smart contract (for example, bytecode), and a to field of the transaction is null. After transaction proliferation and consensus, each node in the Ethereum network can perform the transaction by using the EVM and generate a corresponding contract instance to complete smart contract deployment. In this case, there can be a contract account corresponding to the smart contract on the blockchain, and the contract account has a specific contract address. In an invoking phase, a user (the user can be the same or different from the user deploying the smart contract) sends a transaction for invoking the smart contract to the Ethereum network, where a from field of the transaction is an address of an external account corresponding to the user, a to field is the contract address of the smart contract to be invoked, and a data field contains a method and parameters for invoking the smart contract. After the nodes reach an agreement by using a consensus mechanism, the aforementioned smart contract invoked by the transaction statement is independently executed on each node of the Ethereum network in a specified way, and all execution records and data are stored on the blockchain. Therefore, after the transaction is completed, the blockchain stores a transaction credential that cannot be tampered with and will not be lost. With development of the blockchain technology, in addition to the EVM, a plurality of other types of virtual machines such as WASM (WebAssembly) virtual machines are generated.

In addition, if step 250 is performed on the independent server of the supervision institution, more resources can be saved. If step 250 is performed in the blockchain network, the process of step 250 is transparent to all nodes on the chain, and a generated result is more credible.

Step 260: When the first determining result is yes, the supervision institution generates customs clearance confirmation information used to indicate that the supervision institution permits passage of a product corresponding to the first transaction.

The customs clearance confirmation information is proof that permits passage of the product of the first transaction. The supervision institution can send the customs clearance confirmation information to related parties such as the merchant and the logistics institution in other ways, or can store the customs clearance confirmation information on the chain and notify the related parties on the chain. Specifically, the method can further include the following.

The supervision institution stores the customs clearance confirmation information in the blockchain network; the logistics enterprise obtains the customs clearance confirmation information from the blockchain network; and the logistics enterprise performs, based on the logistics order information and the customs clearance confirmation information, shipment processing on the product corresponding to the first transaction.

Based on the previously described method, the logistics enterprise can obtain the product from an entry temporary storage place by obtaining the customs clearance confirmation information, and send the product to the consumer (buyer) through logistics.

When the customs clearance fails, for example, when the information provided is incomplete and necessary data is lacking, a remedial measure can also be taken. Specifically, the method can further include the following.

When the first determining result is no, the supervision institution generates customs clearance abnormality information for the first transaction; the supervision institution stores the customs clearance abnormality information in the blockchain network; the merchant obtains the customs clearance abnormality information from the blockchain network; the merchant supplements certification documents based on the customs clearance abnormality information; and the merchant stores the certification documents in the blockchain network.

In the method, the customs clearance abnormality information can indicate that customs clearance is not completed or that passage is not permitted. If the abnormality can be solved by supplementing documents, remedial measure information can also be included. The supervision institution can store the customs clearance abnormality information on the blockchain, and can further notify the related parties to perform processing. If there is a problem with the data provided by the merchant, the merchant can submit the certification document. If there is a problem with the data provided by the payment institution or the logistics enterprise, the payment institution or the logistics enterprise can provide the certification document.

The previously described steps can be completed by using the smart contract. It is also possible to indicate in notification information which institution will supplement the certification documents, and then send the pending items to the related parties.

In addition, based on the certification documents, the supervision institution can further continue to perform verification. If the certification documents satisfy requirements, the customs clearance confirmation information can be generated. Specifically, the method can further include the following.

The supervision institution obtains the certification documents from the blockchain network; and the supervision institution performs verification with reference to the certification documents, the transaction order information, the payment order information, and the logistics order information, and when the verification succeeds, generates the customs clearance confirmation information of the first transaction.

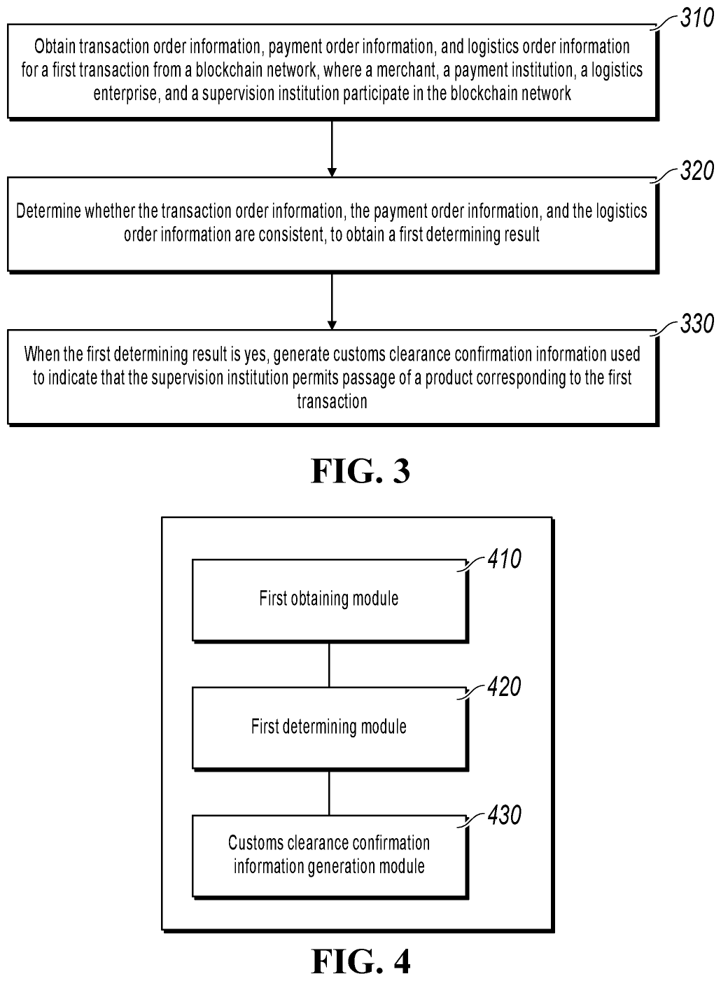

FIG. 3 is a schematic flowchart illustrating a method for generating customs clearance confirmation information with a supervision institution as an execution body. From a program perspective, the procedure can be executed by a program installed on an application server or an application client terminal. As shown in FIG. 3, the method can include the following steps.

Step 310: Obtain transaction order information, payment order information, and logistics order information for a first transaction from a blockchain network, where a merchant, a payment institution, a logistics enterprise, and a supervision institution participate in the blockchain network. The first transaction can be a cross-border transaction.

The transaction order information is information stored by the merchant in the blockchain network, and the transaction order information includes a digital signature of the merchant.

The logistics order information is information stored by the merchant or the logistics enterprise in the blockchain network, and the logistics order information includes a digital signature of the logistics enterprise.

The payment order information is information stored by the payment institution in the blockchain network, and the payment order information includes a digital signature of the payment institution.

The supervision institution obtains transaction information in a certain time period from the blockchain network, and then screens out transaction information meeting a certain condition. Various information of the same transaction can be determined by using the same identifier. Because an order number is indicated during generation of the payment order information and the logistics order information, and the transaction order information also includes the order number, the information of the same transaction can be screened out based on the order number.

Optionally, the obtaining transaction order information, payment order information, and logistics order information for a first transaction from a blockchain network can specifically include: obtaining a transaction information set in a predetermined time period from the blockchain network; determining an order number of the first transaction; and querying the transaction order information, the payment order information, and the logistics order information corresponding to the order number from the transaction set.

Step 320: Determine whether the transaction order information, the payment order information, and the logistics order information are consistent, to obtain a first determining result.

Authenticity of the first transaction can be verified based on correlation between the transaction order information, the payment order information, and the logistics order information.

Step 330: When the first determining result is yes, generate customs clearance confirmation information used to indicate that the supervision institution permits passage of a product corresponding to the first transaction.

In the embodiments, the transaction information can be stored only through the blockchain network, and the supervision institution obtains the transaction data from the blockchain and then stores the obtained transaction data in a local memory before processing. This process is irrelevant to the blockchain. The generated customs clearance confirmation information can be stored by the supervision institution in the blockchain network individually.

Optionally, after step 330, the supervision institution can further store the customs clearance confirmation information in the blockchain network, or send the customs clearance confirmation information to the logistics enterprise of the first transaction, to help the logistics enterprise perform a next operation.

Optionally, the method can further include: when the first determining result is no, generating customs clearance abnormality information for the first transaction; storing the customs clearance abnormality information in the blockchain network; and sending the customs clearance abnormality information to related parties of the first transaction, so that the related parties provide supplementary documents to prove their legitimacy.

For the embodiments, references can be made to the corresponding descriptions of the method provided in FIG. 2.

In addition, steps 310 to 330 can also be performed in the blockchain network, and executed by using a smart contract that has been stored by the supervision institution in the blockchain network and has passed consensus.

Optionally, the determining whether the transaction order information, the payment order information, and the logistics order information are consistent can specifically include: determining buyer information and an order amount of the transaction order information; determining a payment amount of the payment order information; determining consignee information of the logistics order information; and determining whether the buyer information is consistent with the consignee information and whether the order amount is consistent with the payment amount.

To check the three pieces of information is to verify the authenticity of the first transaction, in which it is possible to check whether the three pieces of information correspond to each other. The transaction order information can include the buyer information and seller information, product information, and transaction amount information. The payment order information can include the payment amount. The logistics order information can include the consignee information. The consignee information should be consistent with the buyer information of the transaction order information, and the payment amount should be consistent with the transaction amount.

In addition to checking the consistency of the order information, it is also necessary to check information of the merchant and the buyer. The “consumer” (buyer) is a domestic buyer of a retail imported product in cross-border e-commerce. A cross-border e-commerce platform enterprise or a domestic agent of a cross-border e-commerce enterprise that carries out cross-border e-commerce retail import business shall verify authenticity of the transaction and authenticity of identity (ID) information of the consumer (buyer), and bear corresponding responsibilities. In response to this, the merchant generally needs to submit consumer identity information, such as an ID number, driving license information, or passport information. If the merchant does not verify the ID information of the consumer, the supervision institution can also check the ID of the consumer.

The verification of the consumer ID information can be verification performed by invoking information of a public security institution or a credit reporting agency, to determine whether the consumer is involved in an illegal activity or is a person with a limited consumption capacity, for example, a dishonest person.

Optionally, before the generating customs clearance confirmation information used to indicate that the supervision institution permits passage of a product corresponding to the first transaction, the method can further include: determining merchant information of the transaction order information; obtaining enterprise information and business behavior information of the merchant information; and determining whether the enterprise information and the business behavior information comply with regulations, to obtain a second determining result; and the generating customs clearance confirmation information used to indicate that the supervision institution permits passage of a product corresponding to the first transaction specifically includes: when the second determining result is yes, generating the customs clearance confirmation information used to indicate that the supervision institution permits passage of the product corresponding to the first transaction.

To determine whether the enterprise information and the business behavior information comply with the regulations, information of the industrial and commercial authority or enterprise information stored by the supervision institution can be invoked for checking for the following purposes. The first purpose is to determine whether the merchant has been registered with the supervision institution and can engage in cross-border transactions. The second purpose is to determine whether the merchant information is consistent with the information registered by the industrial and commercial authority. The third purpose is to determine whether the merchant is a high-risk merchant, that is, whether the merchant historically or recently has poor business performance or illegal business behavior.

Enterprises participating in cross-border e-commerce retail import and export business and registered with the customs office can be included in customs credit management, and the customs implements differentiated customs clearance management measures based on credit levels. Therefore, the merchant information can also be verified, to determine whether the merchant information is included in a business abnormality list, etc. For the third case, each merchant can be marked with a risk label, and different operations can be performed based on the risk labels. For a merchant with a low risk or high credit, merchant information can be verified preliminarily. For a merchant with a high risk or low credit, merchant information can be verified twice or three times.

In addition to verifying authenticity of a single transaction, verification can also be performed on a plurality of transactions of the same merchant, to determine whether there is a fraud problem. For example, if a plurality of transactions correspond to the same buyer, and a transaction amount is particularly large, the case may involve fraud or money laundering.

Optionally, the method can further include: determining a risky merchant, where the risky merchant is a merchant with a risk label; determining, from the transaction information set, a transaction information subset corresponding to the risky merchant; determining whether there is an abnormality in each piece of transaction information in the transaction information subset; if there is an abnormality, generating an abnormal result; sending the abnormal result to the risky merchant; and storing the abnormal result in the blockchain network.

For a high-risk merchant, if information of a single transaction is consistent, information of a plurality of transactions of the merchant can also be combined for re-verification. The information of the plurality of transactions can reflect an overall situation of the merchant. Moreover, a plurality of transaction orders in different time periods can also be compared, to determine whether there is a time period with abnormal transactions, for example, a sudden increase of transactions in a certain month. The increase of transactions occurs in many cases. In one case, there is a price-off promotion on special holidays. In another possible case, the orders are virtual orders. It is necessary to determine whether information in the increased transactions includes a plurality of consumers or a fixed quantity of people, and whether a transaction amount is high or low. If the consumers are several fixed people, or the transaction amount is excessively high, illegal behavior such as fund transfer is possibly involved.

Based on the same idea, the embodiments of the present specification further provide an apparatus corresponding to the previously described method. FIG. 4 is a schematic structural diagram illustrating an apparatus corresponding to FIG. 3 and used for generating customs clearance confirmation information according to some embodiments of the present specification. As shown in FIG. 4, the apparatus can include: a first obtaining module 410, configured to obtain transaction order information, payment order information, and logistics order information for a first transaction from a blockchain network, where a merchant, a payment institution, a logistics enterprise, and a supervision institution participate in the blockchain network; a first determining module 420, configured to determine whether the transaction order information, the payment order information, and the logistics order information are consistent, to obtain a first determining result; and a customs clearance confirmation information generation module 430, configured to generate customs clearance confirmation information when the first determining result is yes, where the customs clearance confirmation information is used to indicate that the supervision institution permits passage of a product corresponding to the first transaction.

Based on the apparatus in FIG. 4, the embodiments of the present specification further provide some specific implementations of the method, which are described below.

Optionally, the first determining module 420 can specifically include: a buyer information and order amount determining unit, configured to determine buyer information and an order amount of the transaction order information; a payment amount determining unit, configured to determine a payment amount of the payment order information; a consignee information determining unit, configured to determine consignee information of the logistics order information; and a determining unit, configured to determine whether the buyer information is consistent with the consignee information and whether the order amount is consistent with the payment amount.

Optionally, the apparatus can further include: a merchant information determining module, configured to determine merchant information of the transaction order information; an enterprise information and business behavior information obtaining module, configured to obtain enterprise information and business behavior information of the merchant information; and a second determining module, configured to determine whether the enterprise information and the business behavior information comply with regulations, to obtain a second determining result, where when the second determining result is yes, the customs clearance confirmation information generation module 430 is specifically configured to generate the customs clearance confirmation information used to indicate that the supervision institution permits passage of the product corresponding to the first transaction.

Optionally, the apparatus can further include: a customs clearance confirmation information storage module, configured to store the customs clearance confirmation information in the blockchain network.

Optionally, the apparatus can further include: a customs clearance confirmation information sending module, configured to send the customs clearance confirmation information to the logistics enterprise of the first transaction.

Optionally, the first obtaining module 410 can specifically include: a transaction information set determining unit, configured to obtain a transaction information set in a predetermined time period from the blockchain network; an order number determining unit, configured to determine an order number of the first transaction; and a first obtaining unit, configured to query the transaction order information, the payment order information, and the logistics order information corresponding to the order number from the transaction set.

Optionally, the apparatus can further include: a risky merchant determining module, configured to determine a risky merchant, where the risky merchant is a merchant with a risk label; a transaction information subset determining module, configured to determine, from the transaction information set, a transaction information subset corresponding to the risky merchant; an abnormality determining module, configured to determine whether there is an abnormality in each piece of transaction information in the transaction information subset; an abnormal result generation module, configured to generate an abnormal result if there is an abnormality; an abnormal result sending module, configured to send the abnormal result to the risky merchant; and an abnormal result storage module, configured to store the abnormal result in the blockchain network.

Optionally, the apparatus can further include: a customs clearance abnormality information generation module, configured to generate customs clearance abnormality information for the first transaction when the first determining result is no; a customs clearance abnormality information storage module, configured to store the customs clearance abnormality information in the blockchain network; and a customs clearance abnormality information sending module, configured to send the customs clearance abnormality information to related parties of the first transaction.

Optionally, the transaction order information is information stored by the merchant in the blockchain network, and the transaction order information includes a digital signature of the merchant.

Optionally, the logistics order information is information stored by the merchant or the logistics enterprise in the blockchain network, and the logistics order information includes a digital signature of the logistics enterprise.

Optionally, the payment order information is information stored by the payment institution in the blockchain network, and the payment order information includes a digital signature of the payment institution.

Based on the same idea, the embodiments of the present specification further provide a device corresponding to the previously described method.

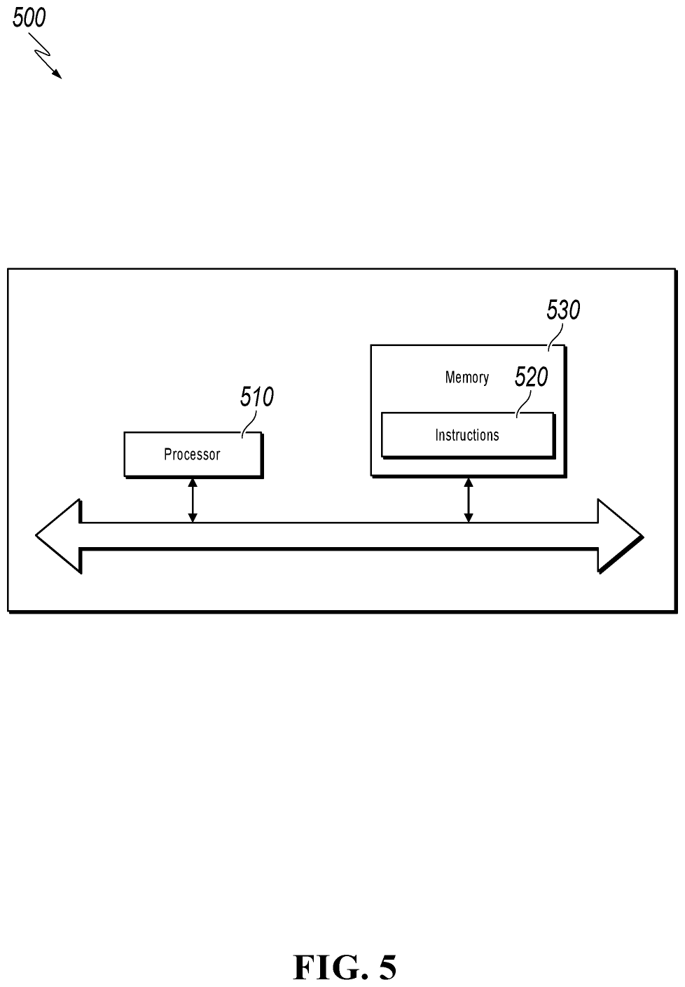

FIG. 5 is a schematic structural diagram illustrating a device corresponding to FIG. 3 and used for generating customs clearance confirmation information according to some embodiments of the present specification. As shown in FIG. 5, the device 500 can include: at least one processor 510; and a memory 530 communicatively connected to the at least one processor.

The memory 530 stores instructions 520 that can be executed by the at least one processor 510, and the instructions are executed by the at least one processor 510, so that the at least one processor 510 can: obtain transaction order information, payment order information, and logistics order information for a first transaction from a blockchain network, where a merchant, a payment institution, a logistics enterprise, and a supervision institution participate in the blockchain network; determine whether the transaction order information, the payment order information, and the logistics order information are consistent, to obtain a first determining result; and when the first determining result is yes, generate customs clearance confirmation information used to indicate that the supervision institution permits passage of a product corresponding to the first transaction.

Based on the same idea, the embodiments of the present specification further provide a computer-readable medium corresponding to the previously described method. The computer-readable medium stores computer-readable instructions, and the computer-readable instructions can be executed by a processor to implement the following method: obtaining transaction order information, payment order information, and logistics order information for a first transaction from a blockchain network, where a merchant, a payment institution, a logistics enterprise, and a supervision institution participate in the blockchain network; determining whether the transaction order information, the payment order information, and the logistics order information are consistent, to obtain a first determining result; and when the first determining result is yes, generating customs clearance confirmation information used to indicate that the supervision institution permits passage of a product corresponding to the first transaction.

Based on the same idea, the embodiments of the present specification further provide a system corresponding to the previously described method and used for generating customs clearance confirmation information. The system includes: a merchant, configured to store transaction order information or logistics order information for a first transaction in a blockchain network; a payment institution, configured to store payment order information for the first transaction in the blockchain network; a logistics enterprise, configured to store the logistics order information for the first transaction in the blockchain network; and a supervision institution, configured to obtain the transaction order information, the payment order information, and the logistics order information from the blockchain network, determine whether the transaction order information, the payment order information, and the logistics order information are consistent, to obtain a first determining result, and when the first determining result is yes, generate customs clearance confirmation information used to indicate that the supervision institution permits passage of a product corresponding to the first transaction.

Optionally, the supervision institution is further configured to store the customs clearance confirmation information in the blockchain network; the logistics enterprise is further configured to obtain the customs clearance confirmation information from the blockchain network; and the logistics enterprise is further configured to perform, based on the logistics order information and the customs clearance confirmation information, shipment processing on the product corresponding to the first transaction.

Optionally, when the first determining result is no, the supervision institution is further configured to generate customs clearance abnormality information for the first transaction, and store the customs clearance abnormality information in the blockchain network; and the merchant is further configured to obtain the customs clearance abnormality information from the blockchain network, supplement certification documents based on the customs clearance abnormality information, and store the certification documents in the blockchain network.

Optionally, the supervision institution is further configured to obtain the certification document from the blockchain network, perform verification with reference to the certification document, the transaction order information, the payment order information, and the logistics order information, and when the verification succeeds, generate the customs clearance confirmation information of the first transaction.

The embodiments in the present specification are described in a progressive way. For same or similar parts of the embodiments, mutual references can be made. Each embodiment focuses on a difference from other embodiments. Particularly, the device for generating customs clearance confirmation information, as shown in FIG. 5, is similar to the method embodiment, and therefore is described briefly. For related parts, references can be made to related descriptions in the method embodiment.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, a current improvement for many method procedures can be considered as a direct improvement of a hardware circuit structure. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming autonomously to “integrate” a digital system into a PLD. There is no need to ask a chip manufacturer to design and manufacture a dedicated integrated circuit chip. Moreover, nowadays, manual manufacturing of integrated circuit chips is being replaced. Such programming is also mostly implemented by using “logic compiler” software instead. The software is similar to a software compiler used to develop and compile a program. However, before compilation, original code also needs to be compiled in a particular programming language. The language is referred to as a hardware description language (HDL). There are many HDLs, such as the Advanced Boolean Expression Language (ABEL), the Altera hardware description language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be in the form of a microprocessor or a processor, or a computer-readable medium that stores computer-readable program code (such as software or firmware) that can be executed by the microprocessor or the processor, a logic gate, a switch, an application specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. A memory controller can also be implemented as a part of the control logic of the memory. A person skilled in the art also knows that, in addition to implementing the controller by using the computer-readable program code, logic programming can be performed on method steps to allow the controller to implement the same function in forms of the logic gate, the switch, the ASIC, the programmable logic controller, and the embedded microprocessor. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit described in the previous embodiments can be implemented by a computer chip or an entity, or implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email receiving and sending device, a game console, a tablet computer, a wearable device, or any combination of these devices.

For ease of description, the apparatus above is described by dividing functions into various units. Certainly, when the present application is implemented, a function of each unit can be implemented in one or more pieces of software and/or hardware.

A person skilled in the art should understand that an embodiment of the present invention can be provided as a method, a system, or a computer program product. Therefore, the present invention can use a form of hardware only embodiments, software only embodiments, or embodiments with a combination of software and hardware. Moreover, the present invention can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on the embodiments of the present specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so that the instructions stored in the computer-readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be a computer-readable instruction, a data structure, a program module, or other data. Examples of the computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. Based on the definition in the present specification, the computer-readable medium does not include transitory media such as a modulated data signal and carrier.

It is also worthwhile to note that the terms “include,” “contain,” or their any other variants are intended to cover a non-exclusive inclusion, so that a process, a method, a product, or a device that includes a list of elements not only includes those elements but also includes other elements not expressly listed, or further includes elements inherent to such process, method, product, or device. Without more constraints, an element preceded by “includes a” does not preclude the existence of additional identical elements in the process, method, product or device that includes the element.

A person skilled in the art should understand that an embodiment of the present application can be provided as a method, a system, or a computer program product. Therefore, the present application can use a form of hardware only embodiments, software only embodiments, or embodiments with a combination of software and hardware. Moreover, the present application can use a form of a computer program product that is implemented on one or more computer-usable storage media (including but not limited to a disk memory, a CD-ROM, an optical memory, etc.) that include computer-usable program code.

The present application can be described in the general context of computer-executable instructions, for example, a program module. Generally, the program module includes a routine, a program, an object, a component, a data structure, etc. executing a specific task or implementing a specific abstract data type. The present application can alternatively be practiced in distributed computing environments in which tasks are performed by remote processing devices that are connected through a communications network. In the distributed computing environment, the program module can be located in both local and remote computer storage media including storage devices.

The previous descriptions are merely embodiments of the present application, and are not intended to limit the present application. A person skilled in the art can make various modifications and changes to the present application. Any modification, equivalent replacement, or improvement made without departing from the spirit and principle of the present application shall fall within the scope of the claims in the present application.

What is claimed is:

1. A computer-implemented method for generating information for customs clearance confirmation, comprising:
receiving, from a blockchain network, transaction order information, payment order information, and logistics order information for a first transaction, wherein the blockchain network comprises a merchant, a payment institution, a logistics enterprise, and a supervision institution;
determining whether the transaction order information, the payment order information, and the logistics order information are consistent; and
in response to determining that the transaction order information, the payment order information, and the logistics order information are consistent, generating customs clearance confirmation information, wherein the customs clearance confirmation information comprises an indication that the supervision institution permits passage of a product corresponding to the first transaction.

2. The computer-implemented method of claim 1, wherein determining whether the transaction order information, the payment order information, and the logistics order information are consistent comprises:
determining buyer information and an order amount of the transaction order information;
determining a payment amount of the payment order information;
determining consignee information of the logistics order information; and
determining whether the buyer information is consistent with the consignee information and whether the order amount is consistent with the payment amount.

3. The computer-implemented method of claim 1, further comprising, before generating the customs clearance confirmation information:
determining merchant information of the transaction order information;
obtaining enterprise information and business behavior information of the merchant information; and
determining that the enterprise information and the business behavior information comply with regulations; and
wherein generating the customs clearance confirmation information comprises, in response to determining that the enterprise information and the business behavior information comply with the regulations, generating the customs clearance confirmation information.

4. The computer-implemented method of claim 1, further comprising:
storing the customs clearance confirmation information in the blockchain network; and
sending the customs clearance confirmation information to the logistics enterprise of the first transaction.

5. The computer-implemented method of claim 1, wherein receiving, from the blockchain network, the transaction order information, the payment order information, and the logistics order information for the first transaction comprises:
receiving, from the blockchain network, a transaction information set in a predetermined time period;
determining an order number of the first transaction; and
querying, from the transaction information set, the transaction order information, the payment order information, and the logistics order information corresponding to the order number.

6. The computer-implemented method of claim 5, further comprising:
determining a risky merchant, wherein the risky merchant comprises a merchant that has been previously associated with a risk label;
determining, from the transaction information set, a transaction information subset corresponding to the risky merchant;
determining whether there is abnormality in any piece of transaction information in the transaction information subset, wherein the abnormality comprises at least one of fraud or money laundering; and
in response to determining that there is abnormality in one or more pieces of transaction information in the transaction information subset,
generating an abnormal result;
sending the abnormal result to the risky merchant; and
storing the abnormal result in the blockchain network.

7. The computer-implemented method of claim 1, further comprising, in response to determining that the transaction order information, the payment order information, and the logistics order information are not consistent,
generating customs clearance abnormality information for the first transaction;
storing the customs clearance abnormality information in the blockchain network; and
sending the customs clearance abnormality information to related parties of the first transaction.

8. The computer-implemented method of claim 1, wherein the transaction order information comprises first information from the merchant, wherein the transaction order information is stored in the blockchain network, and wherein the transaction order information comprises a digital signature of the merchant.

9. The computer-implemented method of claim 1, wherein the logistics order information comprises second information from the merchant or the logistics enterprise, wherein the logistics order information is stored in the blockchain network, and wherein the logistics order information comprises a digital signature of the logistics enterprise.

10. The computer-implemented method of claim 1, wherein the payment order information comprises information from the payment institution, wherein the payment order information is stored in the blockchain network, and wherein the payment order information comprises a digital signature of the payment institution.

11. A non-transitory, computer-readable medium storing one or more instructions executable by a computer system to perform operations comprising:
receiving, from a blockchain network, transaction order information, payment order information, and logistics order information for a first transaction, wherein the blockchain network comprises a merchant, a payment institution, a logistics enterprise, and a supervision institution;
determining whether the transaction order information, the payment order information, and the logistics order information are consistent; and
in response to determining that the transaction order information, the payment order information, and the logistics order information are consistent, generating customs clearance confirmation information, wherein the customs clearance confirmation information comprises an indication that the supervision institution permits passage of a product corresponding to the first transaction.

12. The non-transitory, computer-readable medium of claim 11, wherein determining whether the transaction order information, the payment order information, and the logistics order information are consistent comprises:
determining buyer information and an order amount of the transaction order information;
determining a payment amount of the payment order information;
determining consignee information of the logistics order information; and
determining whether the buyer information is consistent with the consignee information and whether the order amount is consistent with the payment amount.

13. The non-transitory, computer-readable medium of claim 11, wherein the operations further comprise, before generating the customs clearance confirmation information:
determining merchant information of the transaction order information;
obtaining enterprise information and business behavior information of the merchant information; and
determining that the enterprise information and the business behavior information comply with regulations; and
wherein generating the customs clearance confirmation information comprises, in response to determining that the enterprise information and the business behavior information comply with the regulations, generating the customs clearance confirmation information.

14. The non-transitory, computer-readable medium of claim 11, wherein receiving, from the blockchain network, the transaction order information, the payment order information, and the logistics order information for the first transaction comprises:
receiving, from the blockchain network, a transaction information set in a predetermined time period;
determining an order number of the first transaction; and
querying, from the transaction information set, the transaction order information, the payment order information, and the logistics order information corresponding to the order number.

15. The non-transitory, computer-readable medium of claim 14, wherein the operations further comprise:
determining a risky merchant, wherein the risky merchant comprises a merchant that has been previously associated with a risk label;
determining, from the transaction information set, a transaction information subset corresponding to the risky merchant;
determining whether there is abnormality in any piece of transaction information in the transaction information subset, wherein the abnormality comprises at least one of fraud or money laundering; and
in response to determining that there is abnormality in one or more pieces of transaction information in the transaction information subset,
generating an abnormal result;
sending the abnormal result to the risky merchant; and
storing the abnormal result in the blockchain network.

16. The non-transitory, computer-readable medium of claim 11, wherein the operations further comprise, in response to determining that the transaction order information, the payment order information, and the logistics order information are not consistent,
generating customs clearance abnormality information for the first transaction;
storing the customs clearance abnormality information in the blockchain network; and
sending the customs clearance abnormality information to related parties of the first transaction.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, from a blockchain network, transaction order information, payment order information, and logistics order information for a first transaction, wherein the blockchain network comprises a merchant, a payment institution, a logistics enterprise, and a supervision institution;
determining whether the transaction order information, the payment order information, and the logistics order information are consistent; and
in response to determining that the transaction order information, the payment order information, and the logistics order information are consistent, generating customs clearance confirmation information, wherein the customs clearance confirmation information comprises an indication that the supervision institution permits passage of a product corresponding to the first transaction.

18. The computer-implemented system of claim 17, wherein determining whether the transaction order information, the payment order information, and the logistics order information are consistent comprises:
determining buyer information and an order amount of the transaction order information;
determining a payment amount of the payment order information;
determining consignee information of the logistics order information; and
determining whether the buyer information is consistent with the consignee information and whether the order amount is consistent with the payment amount.

19. The computer-implemented system of claim 17, wherein the one or more operations further comprise, before generating the customs clearance confirmation information:
determining merchant information of the transaction order information;
obtaining enterprise information and business behavior information of the merchant information; and
determining that the enterprise information and the business behavior information comply with regulations; and
wherein generating the customs clearance confirmation information comprises, in response to determining that the enterprise information and the business behavior information comply with the regulations, generating the customs clearance confirmation information.

20. The computer-implemented system of claim 17, wherein receiving, from the blockchain network, the transaction order information, the payment order information, and the logistics order information for the first transaction comprises:
receiving, from the blockchain network, a transaction information set in a predetermined time period;
determining an order number of the first transaction; and
querying, from the transaction information set, the transaction order information, the payment order information, and the logistics order information corresponding to the order number.
